(19) United States
(12) Patent Application Publication
(10) Pub. No.: US 2018/0276907 A1
(43) Pub. Date: Sep. 27, 2018

(54) RFID-BASED GENERAL DATA TRANSFER BETWEEN VEHICLE AND EXTERNAL RFID TRANSPONDER

(71) Applicant: Röchling Automotive SE & Co. KG, Mannheim (DE)

(72) Inventor: Domenico Solazzo, Worms (DE)

(73) Assignee: Röchling Automotive SE & Co. KG, Mannheim (DE)

(21) Appl. No.: 15/927,401

(22) Filed: Mar. 21, 2018

(30) Foreign Application Priority Data
Mar. 21, 2017 (DE) 10 2017 204 741.0

(51) Int. Cl. G07C 5/00; B60W 50/04; G06K 19/07; H04W 4/80; H04W 4/44

(52) U.S. Cl. CPC G07C 5/008; B60W 50/045; B60W 2050/0079; H04W 4/80; H04W 4/44; G06K 19/0723

(57) ABSTRACT

A vehicle component assembly has a vehicle control device, a vehicle function component that is different from the vehicle control device, an RFID transponder configured separately from the vehicle control device for identifying at least the vehicle function component, at least one data storage device in which the firmware or/and software allocated to the vehicle function component is stored as a function program packet, and a communication device, which is configured for data communication between the vehicle control device, the RFID transponder, and the data storage device. The vehicle control device and communication device are configured to drive the RFID transponder to set up a wireless RFID communication connection with an RFID transponder that is external with regard to the vehicle component assembly.

### CROSS-REFERENCE TO RELATED APPLICATIONS

This application claims priority to German Application No. DE 10 2017 204 741.0, filed on Mar. 21, 2017, the contents of which are hereby incorporated by reference in its entirety.

### BACKGROUND OF THE INVENTION

### Field of the Invention

The present invention relates to a vehicle component assembly, comprising:

a vehicle control device,

a vehicle function component that is different from the vehicle control device,

an RFID transponder, which is configured for at least identifying the vehicle function component and is allocated to the vehicle function component,

at least one data storage device, in which the firmware or/and software allocated to the vehicle function component is stored as a function program packet, and

a communication device, which is configured for data communication between the vehicle control device, the RFID transponder, and the data storage device.

### Background of the Related Art

From DE 20 2010 012 446 U1 a heatable media line as vehicle function component is known, which is allocated to an RFID transponder, in whose data storage device are stored individual parameter data of the heatable media line. The parameter data in the data storage device of the RFID transponder can be transferred either wirelessly by means of an RFID communication connection or through a conventional vehicle communication bus, such as a CAN or LIN or the like, to a vehicle control device, which individually controls the operation of the heatable media line or in general the vehicle function component based on the parameter data transmitted by the RFID transponder of the media line.

The background of the solution presented in DE 20 2010 012 446 U1 is the most technically efficient solution for taking into account the high production tolerances that occur during the production of heatable media lines.

The individual heating coils of the heater for the media line differ regarding their electric resistance, especially their length-specific electric resistance. It is furthermore not usually known a priori which on-board voltage, whether 12 Volt or 24 Volt, will be used to operate the heating elements.

The heatable media line as vehicle function component obtains, therefore, the individual parameters needed for its operation from the manufacturer in a data storage device. After installation in the vehicle, they are read out by a vehicle control device and used for the operation of the heatable media line. An individualization of the vehicle control device relative to the media line is already prevented in this way by the vehicle manufacturer.

Furthermore, from EP 1 460 575 A an administration system for vehicles is known, in which data that change during the service life of the vehicle are actualized in a rewritable memory of an RFID transponder in a vehicle. A non-rewritable memory area contains identification data concerning the vehicle or/and a vehicle function component so that these cannot be overwritten after a unique allocation. The owner data, owner replacement, information about maintenance, repair, license, accident history, and the like, are stored in the rewritable area of the memory storage device. The vehicle itself becomes thus an information carrier in addition to the vehicle registration document that accompanies the vehicle throughout its service life. The data stored in the RFID transponder of the vehicle can be read out by an external RFID transponder and overwritten by authorized centers.

Errors in the operating software or firmware become known and are eliminated, or the functions stored in the operating software or firmware are improved during the operation of a vehicle with a vehicle function component.

The application of a changed operating software or/and firmware on a vehicle function component requires its actualization in a data storage device containing the corresponding function program packet. Such an actualization is frequently connected with a significant expense.

### SUMMARY OF THE INVENTION

It is, therefore, a very basic object of the present invention to facilitate the exchange of data between the vehicle component assembly and an external data storage device, wherein here not merely the identification data are considered, but data bundles whose size exceeds the usual storage space of an RFID transponder or which are stored in a data storage device of the vehicle component assembly that is separate from the RFID transponder.

This object is attained according to the invention in that the vehicle control device and the communication device are configured for driving the RFID transponder to produce a wireless RFID communication connection with an RFID transponder that is external with regard to the vehicle component assembly.

The basic idea of the present invention is therefore the use of an RFID transponder or its RFID antenna by the vehicle control device for transfer of data or information between the vehicle component assembly and an external RFID transponder, which is necessary to produce a wireless RFID connection as remote station for the RFID transponder on the assembly side.

In this way the convenient possibility is obtained, on the one hand, of identifying a vehicle function component, such as, for example, the air conditioning system, an assembly with driven movable parts, the tire pressure monitoring systems, navigation devices, and so forth, not only via the RFID, but also to produce a real data exchange by means of an RFID communication connection by means of the RFID antenna, which is already available for its identification.

The vehicle control device or the communication device or the RFID transponder is preferably configured to fulfill the task intended for it according to the invention of translating, preferably bidirectionally, a data protocol, which is used in the communication device, into an RFID data transfer protocol. For this purpose, the vehicle component assembly, especially the RFID transponder, can have a converter, which converts bidirectional data that are transferred in the communication device between a format that can be used for the communication device or/and a protocol, and a format that can be used for the RFID transponder or/and protocol. The vehicle control device is moreover configured for operating the RFID transponder or its RFID antenna for emitting and receiving data.

An RFID transponder that is available in the vehicle can thus be expanded to an RFID interface, via which considerably more than only the identification data stored in the RFID transponder can be transferred.

The problem statement that was particularly emphasized above of actualizing the firmware or/and software of the respective vehicle function component through a wireless RFID communication connection under the control of the vehicle control device is preferably considered. Therefore according to an advantageous further development of the present invention, the vehicle control device and the communication device are configured in order to actualize at least part of the function program packet by means of the RFID communication connection that was set up.

The function program packet is preferably fully actualized by means of the RFID communication connection that was set up. However, also the mere partial actualization of the function program packet should be made possible by means of the RFID communication connection, as will be explained in more detail with the aid of the advantageous further developments of the present invention that are presented below. For example, the function program packet can be actualized in several separate partial steps via the respective RFID communication connection that was set up, wherein another external RFID transponder can be the source of the actualization data in the respective steps. However, it should also not be ruled out that one part of the function program packet is actualized with an RFID communication and another part is actualized later by means of another data communication connection.

The RFID transponder allocated to the vehicle function component can basically be provided on the vehicle function component itself, for example, even together with the data storage device, in which the function program packet of the vehicle function component is stored, perhaps in a shared housing or even on a shared electronic component.

However, if the spatial arrangement of the RFID transponder with the data storage device or/and with the vehicle control device, which can also be a control device of the vehicle function component, would be at a location from where the radio waves emitted by the RFID transponder can be barely received outside of the vehicle that carries the vehicle component assembly, the RFID transponder can be arranged on the vehicle function component or in the vehicle itself at a location that is at a distance from the control device or the vehicle control device or/and from the data storage device, which is more advantageous for transmitting and receiving data.

It is even conceivable to arrange the RFID transponder allocated to the vehicle function component on a section of the vehicle component assembly or the vehicle that carries it, which is at a distance from the vehicle function component, to facilitate the data exchange with the RFID transponder.

While the data communication between the RFID transponder and the external RFID transponder is exchanged via data protocols that are usual for these devices, usually another standard is implemented in the vehicle for the data exchange. The communication device is preferably a communication device connected via a wire or physical line that is at least in part a data bus of a vehicle. It can also be the data bus of the vehicle itself. It is therefore provided according to an advantageous further development of the invention that the communication device for data communication between the vehicle control device, the RFID transponder, and the data storage device is configured by means of a standardized protocol, such as perhaps CAN or LIN or the like. A conversion between data formats or/and transfer protocols that may be required can be carried out with the converter mentioned above.

As already disclosed above, the transfer of data can also be carried out only partially in a connecting step and continued later. Information about the currently used firmware or/and software can be stored for this purpose in the data storage device. Information about already received data packets of a not yet completed actualization can be further stored there.

In a particularly advantageous further development of the present invention, the vehicle component assembly serves not only as a receiver of a data bundle but serves as a data source for other vehicle component assemblies after receiving a data bundle or a completed part thereof.

A vehicle-to-vehicle data actualization can be achieved in principle in that the vehicle control device and the communication device are configured for driving the RFID transponder to set up a first RFID communication connection with a first RFID transponder that is outside with regard to the vehicle component assembly and, after receipt of at least one part of a data bundle for actualization of the function program packet via the first RFID communication connection, driving the RFID transponder to set up a second RFID communication connection with a second external RFID transponder that is external with regard to the vehicle component assembly, which is different from the first RFID transponder, to transfer the obtained data bundle or partial data bundle to the second external RFID transponder by means of the second RFID communication connection.

The tremendous advantage of the data actualization or data forwarding from vehicle to vehicle is that the vehicle no longer has to be recalled to a shop for a firmware or/and software actualization, but the required data bundles can be obtained by moving the vehicle within street traffic, namely when a vehicle bearing the vehicle component assembly is located within a sufficient distance to a vehicle with already actualized data, particularly an already partially actualized function program packet. Information about the respective actualization status of the firmware or/and software of the vehicle function component can thus be exchanged initially between the concerned vehicle component assemblies of the different vehicles, for example, during a traffic jam or even with flowing traffic with sufficiently long driving time side by side. After the exchange of these information data and their assessment, the vehicle with actualized firmware or/and software transmits its data via the RFID communication connection to the vehicle with the less current database.

Since the meeting of vehicles with different current databases and thus the database of an RFID communication connection between them can be shorter than the time needed for a complete data transfer, the data are preferably transferred in completed partial data bundles, so that also an incomplete data transfer is helpful.

The advantageous vehicle-to-vehicle data transfer can also be realized in that the first RFID transponder is part of a first external vehicle component assembly that is different from the vehicle component assembly and in that the second external RFID transponder is part of a second external vehicle component assembly that is different from the vehicle component assembly and the first external vehicle component assembly.

To increase the range of the RFID transponder, it is advantageous if the RFID transponder is an active transponder. A passive transponder is basically sufficient. The use of an active transponder beyond the merely increased range is advantageous, however, for the case mentioned above in that the vehicle component assembly can function at one time as a receiver of a data transmission and at another time as a transmitter of a data transmission, since then an RFID communication connection can always be established between the RFID transponder and an external RFID transponder.

To ensure that the data between the RFID transponder and an external RFID transponder are not only transferred within flowing traffic but, for example, also in a parking lot or parking garage, it is advantageous if the vehicle component assembly has a continuous power supply for supplying electric energy independently from an operating state of an installation environment of the vehicle component assembly.

The vehicle control device can thus drive the RFID transponder and the communication device also in parked state for setting up an RFID communication connection. A similar power supply is already known, for example, for vehicle alarm systems.

Since the present invention is particularly advantageous for the mentioned vehicle-to-vehicle data actualization, the invention also relates to a vehicle with a vehicle component assembly such as the one described above.

Since at least two vehicles participate in a vehicle-to-vehicle data transfer, the vehicle pool preferably comprises the vehicle mentioned above as well as another vehicle with the external RFID transponder.

Since precisely the actualization of the function program packet is of particular interest for the present invention, the other vehicle preferably has the external RFID transponder as part of an external vehicle component assembly, so that the other vehicle preferably has the same vehicle function components available as the vehicle itself.

For the case in which the vehicle with the vehicle component assembly is to function once as receiver of a data transmission and is to become a source or transmitter of the data transmission for a third vehicle after conclusion of the data transmission, it is provided that the vehicle pool has a third vehicle with a second external RFID transponder, preferably as part of a second external vehicle component assembly.

The object of the present invention that was mentioned initially is also attained according to a further embodiment of the present invention by means of a method for an actualization of a function program packet allocated to a vehicle function component, comprising firmware or/and software, by means of an RFID transponder, comprising the steps of:
a. Setting up a wireless RFID communication connection between the RFID transponders,
b. Determining a need for actualization of the function program packet and then, once a need for actualization was determined,
c. Transferring at least part of a data bundle for the actualization of the function program packet from one of the RFID transponders as transmitting transponder to the respective other RFID transponder as receiving transponder, at whose receiving side the determined need for actualization exists.

The vehicle component assembly that is described above and is further developed is preferably configured for carrying out the method that was just described. The determination of a need for actualization of the function program packet can be carried out, for example, by comparing the information stored in the data storage device or in a data storage device of the RFID transponder allocated to the vehicle function component via the actualization status of the data, such as perhaps the firmware or/and the software. The RFID transponder that is allocated to the vehicle function component with the current data status becomes here the data source, and the respective other RFID transponder becomes the data receiver.

The determination of the need for actualization can comprise, as presented above, besides the actualization status of the concerned data, an information transfer about parts of the function program packet that were already received within the scope of a data actualization. For example, even if the two RFID transponders of an RFID communication connection of a vehicle function component have already been respectively allocated with the same actualization status, the RFID transponder will become a data source which has a greater but incomplete number of parts of a more current function program packet than is the case for the respective other RFID transponder.

As was explained in detail above, the creation of the wireless RFID communication connection can be the creation of a vehicle-to-vehicle RFID communication connection. This creation of a vehicle-to-vehicle RFID communication connection can be carried out within flowing traffic or in parking lots with parked vehicles.

It should basically however not be ruled out that the data transfer source is a workshop device specifically configured for data transfer, such as perhaps for an actualization of firmware or/and software. The RFID transponder that constitutes a data source can likewise be fixedly installed within the traffic network, perhaps on traffic lights or roadways, so that a vehicle with a vehicle component assembly with actualized database detects the installed RFID transponder, transfers to it a current data bundle if the latter has not yet received it, so that the installed RFID transponder with its data storage device can function as of that moment as data transfer source for vehicles in need of actualization that may approach it later on. Such a fixedly installed RFID transponder as external RFID transponder will be in many cases a passive transponder. If the possibility of connecting to a power source exists, it can also be an active transponder.

According to another basic idea of the invention, which is in common standard inventive correlation with the aspects of the invention mentioned above, the latter also relates to a use of an RFID transponder for transmitting or/and receiving firmware or/and software for a vehicle function component allocated to the RFID transponder.

### BRIEF DESCRIPTION OF THE DRAWING FIGURES

The present invention will be described in more detail below with the aid of the enclosed drawings, wherein:

FIG. 1 shows a crude schematic representation of a vehicle component assembly according to the invention within a vehicle,

FIG. 2 shows an example of a data transfer from vehicle to vehicle in a parking lot,

FIG. 3 shows the example of FIG. 2 in a stage that is chronologically further advanced.

### DETAILED DESCRIPTION OF THE PREFERRED EMBODIMENTS

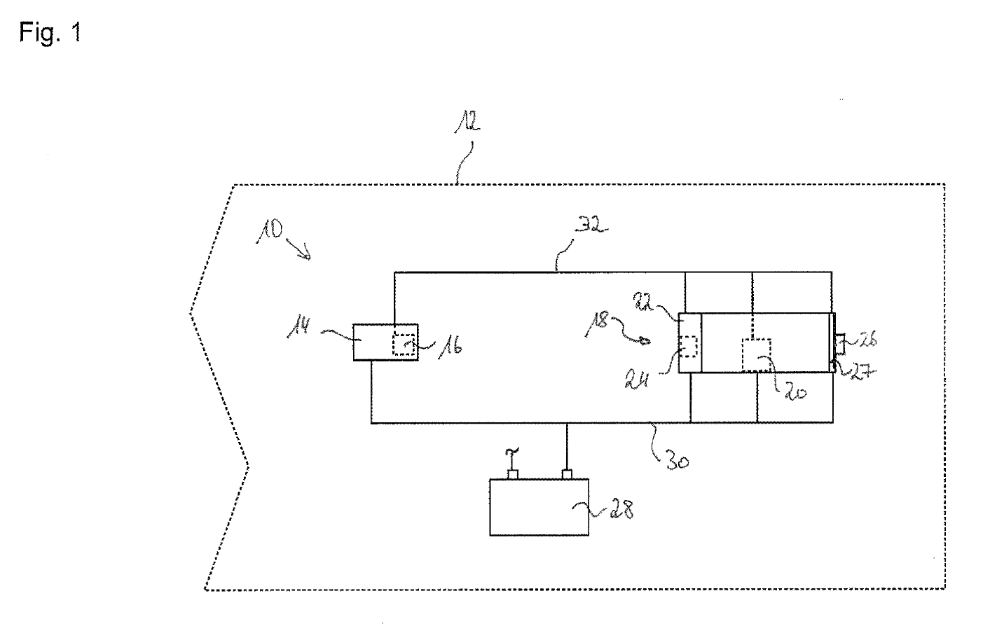

An exemplary embodiment of a vehicle component assembly according to the invention, which is merely crudely schematically represented for explanatory purposes, is generally identified with reference numeral 10 in FIG. 1. The vehicle component assembly is located in a likewise only crudely schematically indicated vehicle 12. It can be basically a land vehicle, watercraft, or aircraft, but is preferably a land vehicle, such as, for example, a passenger car or/and a truck or two-wheeler.

The vehicle component assembly 10 comprises a main control device 14 with a data storage device 16 contained therein.

The vehicle component assembly 10 further comprises a vehicle function component 18, for example, a tank for storage and controlled delivery of aqueous urea solution, wherein the tank 18 has a function module 20 operable by means of power supply, for example, a heater or/and an extraction pump for extracting urea solution from the tank.

The vehicle function component 18 is a component control device 22 allocated with a component data storage device 24 that cooperates with the component control device 22. The component control device 22 can control the operation of the function module 20, which confirms the allocation of the component control device 22 to the vehicle function component 18.

The main control device 14 as well as the component control device 22 constitute a vehicle control device in the sense of the present invention, since both control devices are located in the vehicle 12 and are suitable and intended for use in a vehicle.

The vehicle function component 18 (tank) comprises an RFID chip 26 with a component identification permanently stored therein. It is connected to a CAN-RFID converter 27, which transmits a data stream transmitted in the CAN bus system 32 according to the data protocol that is customary therein into a data stream that is usable for the RFID chip, according to a data protocol that is usable in the RFID chip 26 and vice versa.

The vehicle component assembly 10 is connected to a vehicle battery 28 for supplying the vehicle component assembly 10 with electric current. The connection is set up by means of a power connection line 30.

The power supply connection through the power supply line 30 is a so-called continuous connection line, which constantly supplies the vehicle component assembly 10 with electric energy, that is, in the present case the main control device 14, the component control device 22, the function module 20, the RFID chip 26, and the CAN RFID converter 27, independently from the operating state of the vehicle.

In the case of function module 20, this is not absolutely necessary, but it is advantageous in the shown example of a tank 18 for aqueous urea solution, to be able to prevent an undesirable freezing of the aqueous urea solution in the tank 18 when the vehicle 12 is parked with the ignition key removed.

The vehicle component assembly 10 further comprises a communication device 32 in the form of the CAN bus already mentioned above with allocated line arrangement. The communication device 32 makes possible a communication between the main control device 14, the component control device 22, the function module 20, the CAN-RFID converter 27, and the RFID chip 26. The main control device 14 or the component control device 22 or both control devices 14/22 are configured for driving and operating an RFID antenna of the RFID chip 26 to set up a wireless RFID communication connection with an external RFID transponder.

The RFID chip 26 is an RFID transponder 26 in the sense of the present application. It is configured as an active transponder 26 because it is continuously connected in an energy-transmitting manner to the power source 28 via the power supply line 30.

Because an active RFID transponder 26 is used, its range is increased in comparison to a passive RFID transponder. Passive RFID transponders receive the energy required for their operation through the external RFID transponder communicating with them.

A firmware or/and software for operation of the function module 20 is stored in the data storage device 16 or the data storage device 24, preferably in the data storage device 24 of the component control device 22. This operating sequence programming is generally known as a function program packet and is executed by the main control device 14 or the component control device 22. The function program packet can define the control of the function module depending on time or/and operating parameters or/and sensor values. The vehicle component assembly 10 can, therefore, be connected to sensors or it can comprise sensors whose values are likewise incorporated into the operation of the function module 20. The retrieval of information from sensors, for example, by means of the component control device 22, can also be defined by the function program packet. The main control device 14 can alternatively or additionally supply the sensor values available to it to the component control device 22.

The component control device 22 can alternatively be omitted and the vehicle function component 18 can be operated exclusively by the main control device 14.

Information about the actualization status of the function program packet is advantageously stored in one of the data storage devices 16 and 24, preferably in the data storage device that also contains the function program packet.

If the vehicle 12 equipped with the vehicle component assembly 10 comes sufficiently close, in any situation, to another vehicle that also has a vehicle component assembly 10 or a comparable assembly, the main control device 14 or the component control device 22 actuates the RFID transponder 26 to set up an RFID communication connection with the external RFID transponder of the other vehicle and establishes a wireless RFID communication connection.

After setting up the RFID communication connection, the respective actualization data that are stored in the data storage devices 16 or/and 24 for the respective function program packet are compared. Depending on the result of the comparison, if no need for actualization is detected, the RFID communication connection is again severed, or the vehicle with the lower actualization status receives data with the higher actualization status via the RFID communication connection.

A need for actualization can be determined, for example, in that either the actualization status of a function program packet of a vehicle is newer than in another vehicle, or both function program packets have the same actualization status, but several data bundles of a still incompletely actualized, newer function program packet are located in one of the data storage devices 16 or 24.

Subsequently, the data are transferred through the RFID antenna of the RFID transponders 26, from the vehicle with the more current status to the vehicle with the need for actualization, and likewise are received by the respective other vehicle.

The data are read out for this purpose from the data storage device 16 or 24 and transferred via the CAN bus 32 to the RFID transponder 26, where the RFID transponder 26 is driven by means of commands of the main control device 14 or the component control device 22 to transfer the data to the external RFID receiver.

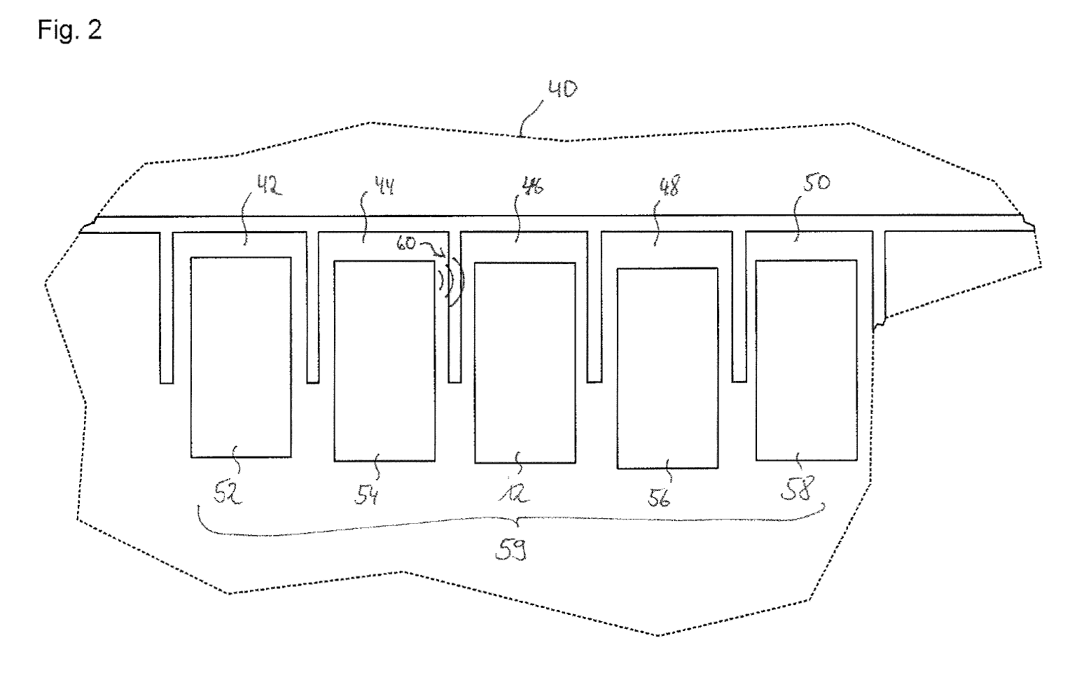

FIG. 2 shows a section of a parking lot 40. The vehicles 52, 54, the vehicle 12 of FIG. 1, as well as the vehicles 56 and 58 are parked in individual parking bays 42 to 50.

The vehicles 12 and 52 to 58 have each a vehicle component assembly 10. After the vehicles 12 and 52 to 58 are parked, RFID communication connections are established between the vehicles that are at a sufficient distance to each other for the range of the RFID transponder 26. After the RFID communication connection is set up, the actualization statuses of the respectively contained function program packets are compared. The vehicles 12 and 52, 54, 56 and 58 constitute an exemplary vehicle pool 59 in the sense of the present invention.

Because of its range, it is assumed that each RFID transponder 26 of each of the vehicles 12 and 52 to 58 is only able to reach the vehicle directly adjacent to it.

During the comparison of actualization statuses, it is determined that the vehicle 54 had the most current version of the function program packet. The vehicle 54 thereupon actualizes the function program packet 52 of the vehicle 52 by utilizing an RFID communication connection set up with the vehicle 52 to transfer the data bundles necessary for this purpose to the vehicle 52 via the RFID communication connection. The vehicle 54 subsequently establishes an RFID communication connection with the vehicle 12 and transfers the data bundle necessary for the actualization of the function program packet via the RFID communication connection 60 to the vehicle 12. This is shown in FIG. 2.

After the vehicle 12 has thus obtained an actualization of its function program packet, the actualization status of the function program packet in the vehicle 12 is more current than the one of the function program packet of the adjacent vehicle 56.

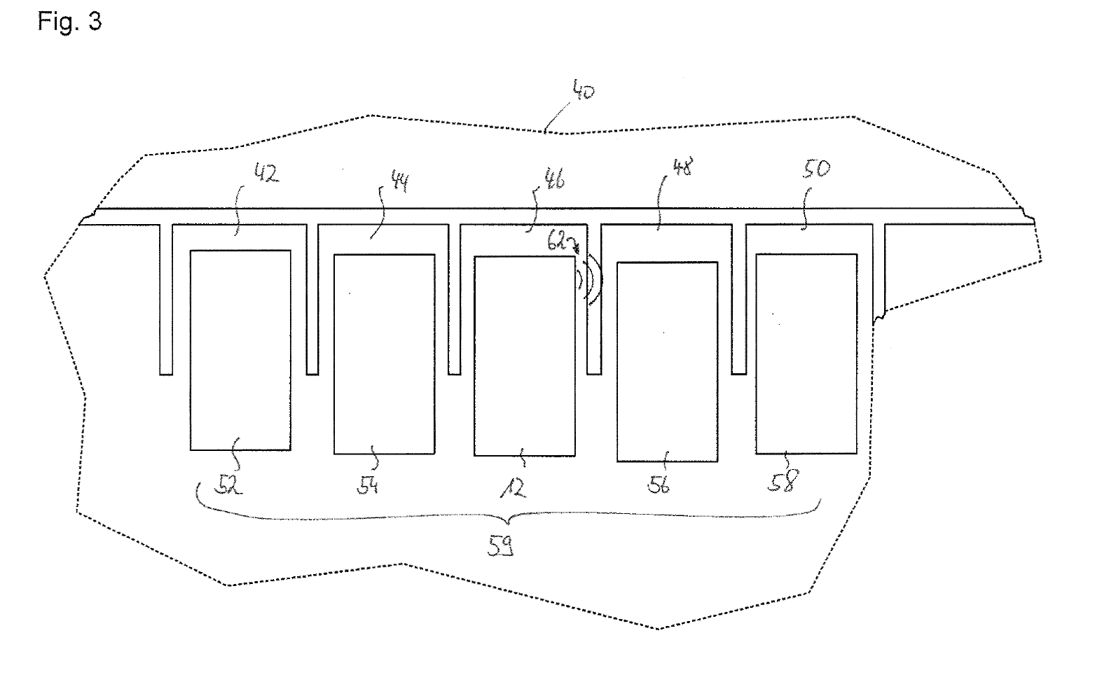

A renewed RFID communication connection can be set up with the vehicle within range, for example, after an actualization has taken place or in general after a change of the actualization status of the own function program packet to again determine a need for actualization with the now changed actualization status. In the present case of FIG. 3, a need for actualization of the vehicle 56 relative to the vehicle 12 is determined, whereupon the RFID transponder 26 of the vehicle 12 is driven by means of the main control device 14 or the component control device 22 to transfer data by means of the set-up RFID communication connection 62 with the vehicle 56, so that the vehicle 56 also receives an actualization of its function program packet by means of the RFID communication connection 62.

An actualization of all vehicles parked in the parking lot can be successively carried out in this way with a sufficient range of the RFID transponder 26 when a single actualized vehicle is parked in the parking lot, provided the duration of parking is sufficiently long.

At least a partial actualization by means of the transfer of at least one partial data packet can take place if the duration of parking is not sufficiently long.

1. A vehicle component assembly comprising:
a vehicle control device;
a vehicle function component that is different from the vehicle control device;
an RFID transponder configured separately from the vehicle control device, which is configured for identifying at least the vehicle function component and is allocated to the vehicle function component;
at least one data storage device, in which the firmware or/and software allocated to the vehicle function component is stored as a function program packet; and
a communication device, which is configured for a data communication between the vehicle control device, the RFID transponder, and the data storage device, wherein the vehicle control device and the communication device are configured for the purpose of driving the RFID transponder to set up a wireless RFID communication connection with an RFID transponder that is external with regard to the vehicle component assembly.

2. The vehicle component assembly according to claim 1,
wherein the vehicle control device and the communication device are configured for actualizing at least part of the function program packet by means of the set-up RFID communication connection.

3. The vehicle component assembly according to claim 1,
wherein the communication device is configured for a data communication between the vehicle control device, the RFID transponder, and the data storage device by means of a standardized protocol, such as perhaps CAN or LIN or the like.

4. The vehicle component assembly according to claim 2,
wherein the vehicle control device and the communication device are configured for driving the RFID transponder to set up a first RFID communication connection with a first RFID transponder that is outside relative to the vehicle component assembly and, after receipt of at least one part of a data bundle for actualization of the function program packet via the first RFID communication connection, driving the RFID transponder to set up a second RFID communication connection with a second external RFID transponder that is external with regard to the vehicle component assembly, which is different from the first RFID transponder, to transfer the obtained data bundle or partial data bundle to the second external RFID transponder by means of the second RFID communication connection.

5. The vehicle component assembly according to claim 4,
wherein the first external RFID transponder is part of a first external vehicle component assembly that is different from the vehicle component assembly or/and the second external RFID transponder is part of a second external vehicle component assembly that is different from the vehicle component assembly and the first external vehicle component assembly.

6. The vehicle component assembly according to claim 1,
wherein the RFID transponder is an active transponder.

7. The vehicle component assembly according to claim 1,
wherein the vehicle component assembly has a continuous power supply for supplying electric energy independently from an operating state of an installation environment of the vehicle component assembly.

8. A vehicle with a vehicle component assembly according to claim 1.

9. A vehicle pool, comprising the vehicle according to claim 8, and at least one other vehicle with the external RFID transponder.

10. The vehicle pool according to claim 9,
wherein the other vehicle has the external RFID transponder as part of an external vehicle component assembly.

11. The vehicle pool according to claim 10,
wherein the vehicle pool has a third vehicle with a second external RFID transponder.

12. A method for actualizing a function program packet allocated to a vehicle function component, comprising firmware or/and software, by means of an RFID transponder, said method comprising the steps of:
setting up a wireless RFID communication connection between the RFID transponders,
determining a need for actualization of the function program packet, and once a need for actualization was determined, and
transferring at least part of a data bundle for the actualization of the function program packet from one of the RFID transponders as transmitting transponder to the respective other RFID transponder as receiving transponder, at whose receiving side the determined need for actualization exists.

13. The method according to claim 12,
wherein the set-up of the wireless RFID communication connection is a set-up of a vehicle-to-vehicle RFID communication connection.

14. A use of an RFID transponder for transmitting or/and receiving firmware or/and software for a vehicle function component allocated to the RFID transponder.

15. The vehicle component assembly according to claim 3,
wherein the vehicle control device and the communication device are configured for driving the RFID transponder to set up a first RFID communication connection with a first RFID transponder that is outside relative to the vehicle component assembly and, after receipt of at least one part of a data bundle for actualization of the function program packet via the first RFID communication connection, driving the RFID transponder to set up a second RFID communication connection with a second external RFID transponder that is external with regard to the vehicle component assembly, which is different from the first RFID transponder, to transfer the obtained data bundle or partial data bundle to the second external RFID transponder by means of the second RFID communication connection.

16. The vehicle component assembly according to claim 2,
wherein the RFID transponder is an active transponder.

17. The vehicle component assembly according to claim 3,
wherein the RFID transponder is an active transponder.

18. The vehicle component assembly according to claim 4,
wherein the RFID transponder is an active transponder.

19. The vehicle component assembly according to claim 5,
wherein the RFID transponder is an active transponder.

20. The vehicle pool according to claim 10,
wherein the vehicle pool has a third vehicle with a second external RFID transponder as part of a second external vehicle component assembly.
